(19) United States
(12) Patent Application Publication
(10) Pub. No.: US 2007/0167885 A1
(43) Pub. Date: Jul. 19, 2007

(54) Massage belt

(76) Inventor: Young-Jin Moon, Seoul (KR)

Correspondence Address: MAYER, BROWN, ROWE & MAW LLP, 1909 K STREET, N.W., WASHINGTON, DC, 20006, US

(21) Appl. No.: 10/558,752

(22) PCT Filed: Jul. 28, 2005
(86) PCT No.: PCT/KR05/02449

§ 371 Date: Dec. 1, 2005

(51) Int. Cl. A61H 1/00

(52) U.S. Cl. 601/71; 601/67; 601/69; 601/79

(57) ABSTRACT

A conventional massage belt provides monotonous sense in use and simple massage effect caused from the rotational motion that draws a simple trajectory in only a forward or reverse direction when a particular body portion is massaged with vibration of the same rotational speed generated from a vibrating portion in which eccentric weights are installed at both sides of a motor and which is installed in a belt body tightly wrapped around the body portion to be massaged such as abdomen. The present invention provides a massage belt wherein when a relevant body portion is massaged with elliptic vibrations generated from vibration generators, in each of which a motor and an eccentric weight at a side of the motor are installed and which are installed in a belt body at a predetermined interval, continuous rotational motions variously changed due to the combination of vibrations generated from the vibration generators operating simultaneously at different rotational speeds and/or intensity of the elliptic vibrations are applied to the relevant body portion, thereby maximizing a variety of massage effects and interest occurring in use.

### TECHNICAL FIELD

The present invention relates to a massage belt, and more particularly, to a massage belt in which vibration generators are installed in a belt body tightly wrapped around a particular body portion such as abdomen, waist or thigh such that a massage function can be performed using vibrations caused from eccentric rotational forces generated from the vibration generators.

### BACKGROUND ART

In general, a belt having a simple shaking function and a belt having a patting function using a vibrator installed to a contact portion thereof have been used as a belt for performing a massage operation. Such a conventional belt provides only a single function, i.e. a shaking or patting operation, to a body portion of a user such as abdomen with which the belt is brought into close contact, so that the user feels only a simple massage effect.

Thus, in order to complement the foregoing, Korean Utility Model Registration No. 0345251 suggests an electric massage belt, in which a belt body that is wrapped around abdomen, waist or the like is provided with a vibrating portion for simultaneously performing shaking and patting functions and the vibrating portion includes a motor and a vibrating body connected thereto through a timing belt, thereby obtaining a diet effect as well as a massage effect during the massage operation of the massage belt.

As shown in FIG. 1, the aforementioned electric massage belt 100 comprises a belt body 130 with fastening means such as a magic tape provided at both ends thereof to tightly wrap around abdomen or the like; a vibrating portion 200 installed in the middle of the belt body 130 to massage the close contact portion with a vibration caused from an eccentric rotational force generated when power is supplied; a power supply 400 for receiving external electric power and supplying a driving force to the vibrating portion 200; a key operating portion 110 provided on a certain position at a side of the belt body 130 to control an on/off operation or vibration intensity of the vibrating portion 200 by controlling the electric power applied from the power supply 400; a controller 300 formed to be separated from the belt body 130 and connected to the vibrating portion 200 by a wire to control the on/off operation or vibration intensity of the vibrating portion 200 and a temperature of a heating wire by controlling the power applied from the power supply 400; and heaters 120 generating heat when the power supply 400 supplies the electric power thereto, positioned at both sides of the vibrating portion 200, and including bio-ceramics and heating wires for causing far infrared rays to be emitted from the inside of the close contact portion with which the body portion to be massaged is brought into close contact.

As shown in FIGS. 2 and 3, such a conventional electric massage belt 100 operates in such a manner that the vibrating portion 200 for generating vibration causes a single drive motor 220 to rotate two eccentric rotors 280 simultaneously through a timing belt 290.

Thus, since the two eccentric rotors 280 are driven and rotated by the single drive motor 220, they rotate at a uniform rotational speed. In such a case, as seen from FIGS. 4 and 5 illustrating such a process that the vibrating portion 200 operates to draw a continuous rotational motion trajectory in a forward or reverse direction in a state where the massage belt 100 is wrapped around the body portion, the rotational motion generated when the relevant body portion is massaged draws the simple trajectory only in the forward or reverse direction, thereby resulting in monotonous sense in use and simple massage effect.

### DISCLOSURE

[Technical Problem]

The present invention is conceived to solve the aforementioned problems in the prior art. An object of the present invention is to provide a massage belt wherein respective elliptic vibrations generated differently when vibration generators for performing a massage function, which are installed at both sides in a belt body at a predetermined interval to be tightly wrapped around a particular body portion such as abdomen or waist, are simultaneously operated at different rotational speeds and intensity of the vibrations are combined with each other and applied to a desired body portion in the form of a variously changing continuous rotational motion, whereby a variety of massage effects and interest occurring in use can be maximized.

[Technical Solution]

According to the present invention for achieving the objects, there is provided a massage belt, comprising a belt body tightly wrapped around a body portion to be massaged such as abdomen; and vibration generators installed at both sides in the belt body at a predetermined interval for generating elliptic vibrations and applying the generated vibrations to the relevant body portion, each comprising a housing, a rotational driving means installed at one side in the housing, an eccentric rotational force generating means installed at the other side in the housing for receiving a rotational driving force from the rotational driving means and generating an eccentric rotational force, and a rotational driving force transmitting means for connecting the rotational driving means and the eccentric rotational force generating means to thereby transmit the rotational driving force of the rotational driving means to the eccentric rotational force generating means, wherein the vibration generators operate at different rotational speeds and/or intensity of elliptic vibrations to generate vibrations, and continuous rotational motions variously changed due to the combination of the vibrations generated from the vibration generators are applied to the relevant body portion, thereby maximizing a variety of massage effects and interest occurring in use.

Preferably, each of the vibration generators weighs 430 to 730 grams and the massage belt weighs 1300 to 1800 grams as a whole.

Preferably, the eccentric rotational force generating means comprises a connecting shaft with both upper and lower ends being rotatably installed in both upper and lower portions of the other side of the housing, connecting shaft ball bearings for causing the connecting shaft to rotate smoothly, connecting shaft noise prevention rubbers surrounding around the connecting shaft ball bearings to reduce noise when the connecting shaft rotates, an eccentric weight fixed on the connecting shaft to generate the eccentric rotational force, and an eccentric weight pulley fitted and fixed to the eccentric weights.

Preferably, a heating portion is further installed in the belt body.

Preferably, a belt motion displaying portion is further installed on an upper end of the belt body to visually indicate the continuous rotational motions variously changed due to the combination of elliptic vibrations generated from the respective vibration generators.

### DESCRIPTION OF DRAWINGS

FIG. 1 is a view showing a state where a conventional massage belt is spread;

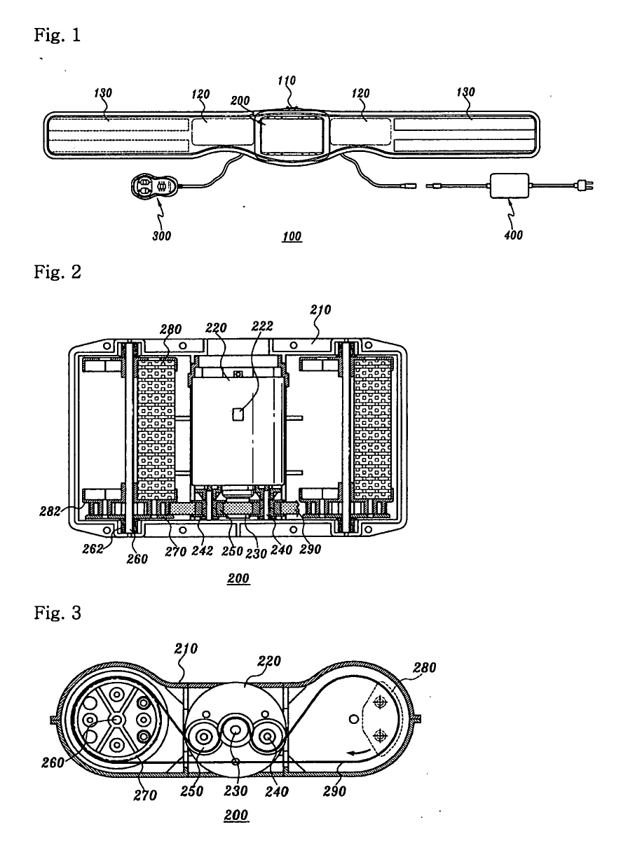

FIGS. 2 and 3 are front and plan sectional views showing a vibrating portion of the conventional massage belt;

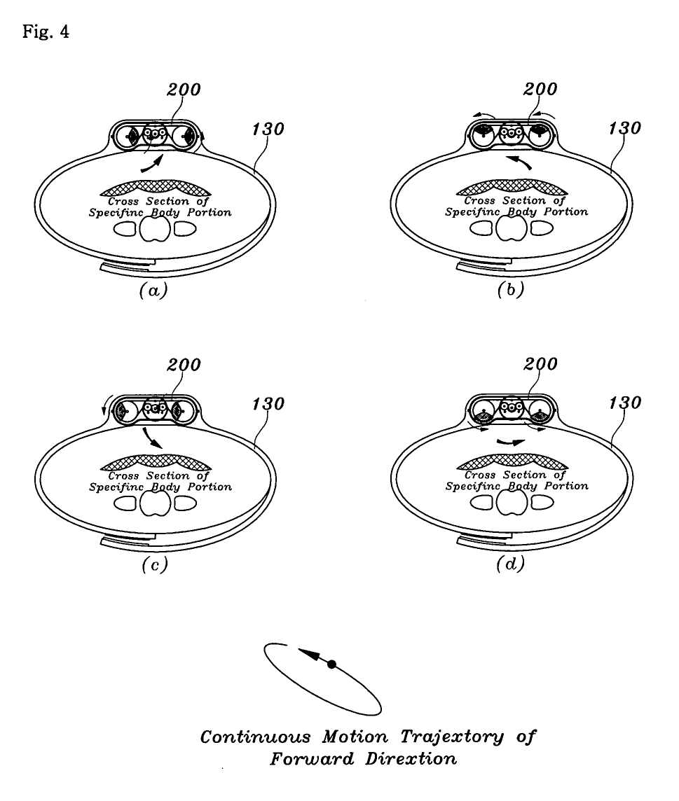

FIGS. 4 and 5 are views showing that the vibrating portion operates to draw a continuous rotational motion trajectory in a forward or reverse direction in a state where the massage belt of FIG. 1 is wrapped around a particular body portion;

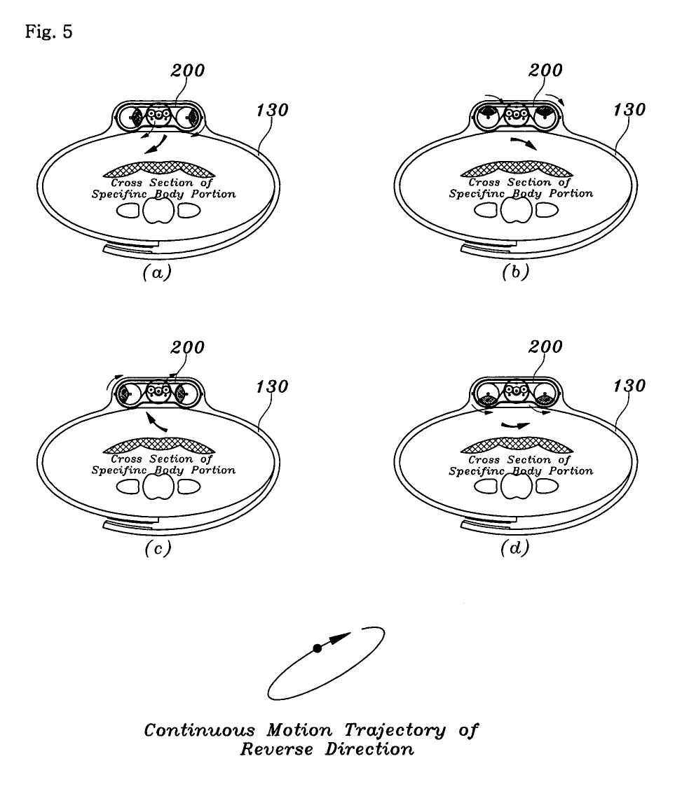

FIG. 6 is a view a state where a massage belt according to an embodiment of the present invention is spread;

FIG. 7 is a plan sectional view of FIG. 6;

FIG. 8 is a view showing an external appearance of a vibration generator of the massage belt according to the embodiment of the present invention;

FIGS. 9 and 10 are front and plan sectional views of FIG. 8;

FIG. 11 is a view showing that the massage belt operates to draw a continuous rotational motion trajectory due to the combination of respective elliptic vibrations generated from vibration generators which simultaneously operate at different rotational speeds and/or intensity of the vibrations; and

FIGS. 12 and 13 are sectional views showing a state where a massage belt according to another embodiment of the present invention is wrapped around a particular body portion.

### EXPLANATION OF REFERENCE NUMERALS FOR MAJOR PORTIONS SHOWN IN DRAWINGS

| | |
|---|---|
| 10: massage belt according to embodiments of the present invention | |
| 11: belt body | 111: Velcro tape |
| 112: pocket portion for receiving vibration generator | |
| 12: vibration generator | 121: rotational driving means |
| 1211: motor | 1212: temperature switch |
| 1213: motor pulley | |
| 122: eccentric rotational force generating means | |
| 1221: connecting shaft | 1222: connecting shaft ball bearing |
| 1223: connecting shaft noise prevention rubber | |
| 1224: eccentric weight | 1225: eccentric weight pulley |
| 123: rotational driving force transmitting means | |
| 124: housing | 1241: cooling vent |
| 13: heating portion | 131: heater |
| 132: insulation member | 14: power supply |
| 15: controller | 16: belt motion displaying portion |

[Best Model]

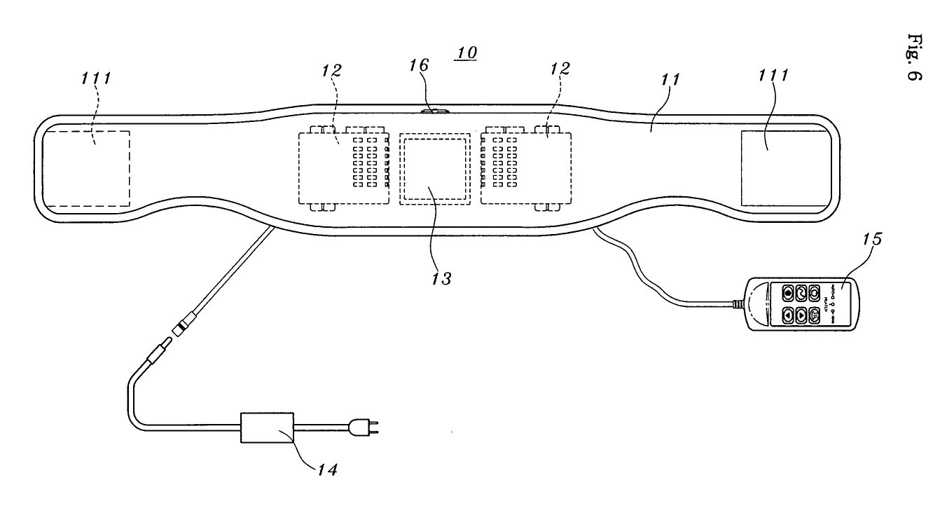

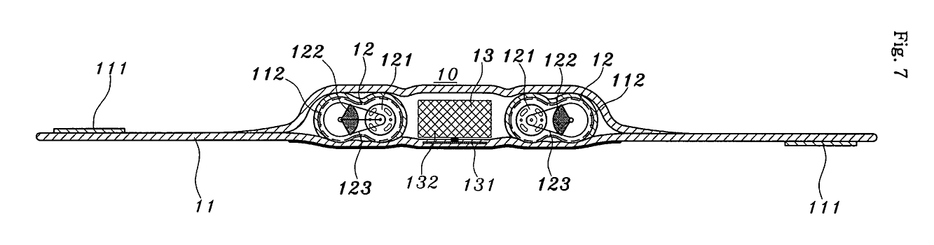

As shown in FIGS. 6 and 7, a massage belt 10 according to an embodiment of the present invention comprises a belt body 11 that is tightly wrapped around a body portion to be massaged such as abdomen or waist, vibration generators 12 installed on a front surface of the belt body 11 at a predetermined interval in order to provide elliptic vibrations to the desired body portion, a heating portion 13 installed between the vibration generators 12, a power supply 14 for supplying power to the vibration generators 12 and the heating portion 13, a controller 15 formed as a separate part from and connected to the belt body 11 by wire to control an on/off operation or vibration intensity of the vibration generators 12 and the heating temperature of the heating portion 13 by controlling the electric power supplied from the power supply 14, and a belt motion displaying portion 16 installed on the upper end of the belt body 11 to allow a user to visually confirm the overall motion of the belt according to the elliptic vibrations of the vibration generators 12.

The belt body 11 is formed with a predetermined area and shape to be capable of wrapping around abdomen or the like. To this end, the belt body 11 is provided with fastening means such as Velcro tapes 111 at both ends thereof such that it can be easily wrapped around the body portion. Further, the belt body 11 may be made of an elastic member such that it can be brought into close contact with the specific body portion to be massaged.

Furthermore, in order to more securely fix the vibration generators 12 that generate vibrations to the extent that the massage function can be smoothly performed, pocket portions 112 for receiving the vibration generators, which are formed of the same material as the belt body 11 or a material with appropriate strength, are installed in the belt body 11.

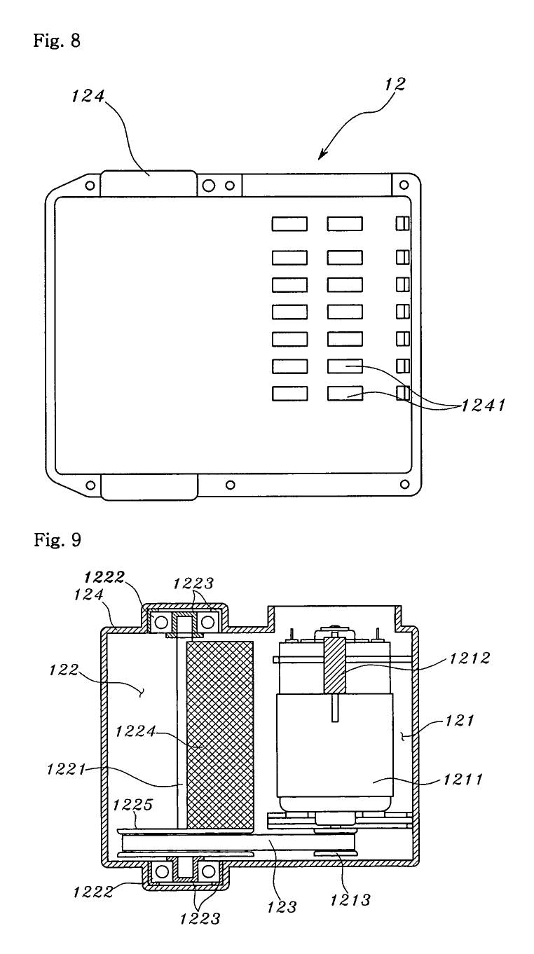

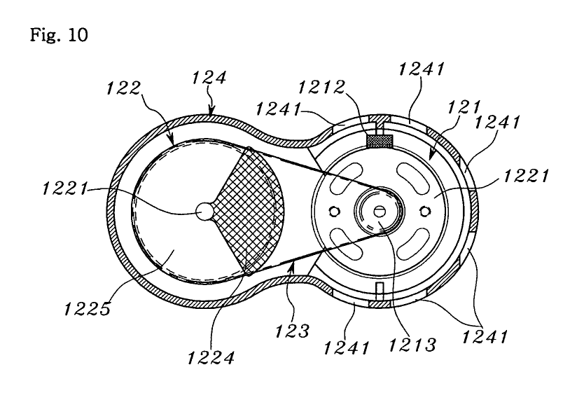

As shown in FIGS. 8 to 10, each of the vibration generators 12 comprises a housing 124, a rotational driving means 121 installed at one side in the housing 124, an eccentric rotational force generating means 122 installed at the other side in the housing 124 to receive a rotational driving force from the rotational driving means 121 and generate an eccentric rotational force, and a rotational driving force transmitting means 123 for connecting the rotational driving means 121 and the eccentric rotational force generating means 122 to transmit the rotational driving force of the rotational driving means 121 to the eccentric rotational force generating means 122.

In the embodiment of the present invention, each of the vibration generators 12 weighs about 430 to 730 grams and thus give a predetermined stimulus to the body portion such as abdomen of the adult such that optimal massage sense and effect can be obtained. Here, the massage belt 10 according to the embodiment of the present invention weighs about 1300 to 1800 grams including the weight of the vibration generators 12 as a whole and thus can provide the optimal massage sense and effect when the general adult wears the massage belt to enjoy the massage.

To this end, the rotational driving means 121 and the eccentric rotational force generating means 122 are installed in a side of each vibration generator 12 in parallel with each other, so that the vibration generator 12 generates a large force with an even smaller volume. In such a case, the vibration generator 12 generates the elliptic vibration.

Each of the rotational driving means 121 comprises a motor 1211 positioned in one side of the housing 124 to generate the rotational driving force, and a motor pulley 1213 rotatably installed to a shaft of the motor 1211 to transmit the rotational driving force to the eccentric rotational force generating means 122.

In addition, a temperature switch 1212 is provided in one side of the motor 1211 to automatically cut off the electric power when the motor 1211 is overheated due to the continuous rotation thereof, so that it can prevent the damage due to the overheating of the motor 1211 and the injury of a user.

Each of the eccentric rotational force generating means 122 comprises a connecting shaft 1221 with both upper and lower ends rotatably installed in both upper and lower portions of the other side of the housing 124, connecting shaft ball bearings 1222 for causing the connecting shaft 1221 to rotate smoothly, connecting shaft noise prevention rubbers 1223 surrounding around the connecting shaft ball bearings 1222 to reduce noise generated when the connecting shaft 1221 rotates, an eccentric weight 1224 fixed on the connecting shaft 1221 to generate the eccentric rotational force, and an eccentric weight pulley 1225 fitted and fixed to the eccentric weights 1224.

The connecting shaft ball bearings 1222 and the connecting shaft noise prevention rubbers 1223 solve the problems that a conventional oilless bearing installed for smoothing the rotation of a connecting shaft severely wears by eccentric centrifugal force of the eccentric rotor and generates lots of noises as it is continuously used. To this end, the connecting shaft ball bearings 1222 are enveloped with rubber of hardness of 90, so that noise is prevented and shock-absorbing function against the applied eccentric centrifugal force is obtained.

The eccentric weight 1224, which is formed in a cylindrical shape with a semi-circular or fan-shaped cross section and an erected surface of which is integrally joined to the connecting shaft 1221, is integrally joined to the connecting shaft 1221 to rotate.

The rotational driving force transmitting means 123, such as a timing belt, connects the motor pulley 1213 and the eccentric weight pulley 1225, and thus transmits the rotational driving force of the motor 1211 to the eccentric weight 1224 which is the next step.

In order to prevent a temperature according to the operation of the motor 1211, particular the rotational driving means 121 from rising, the housing 124 is formed with a plurality of cooling vents 1241 around the position in which the rotational driving means 121 is installed.

As compared with the conventional massage belt 100, wherein the vibrating portion 200 for generating vibration operates to simultaneously rotate the two eccentric rotors 280 through the timing belt 290 using the single motor 220 and the two eccentric rotors 280 are driven by the single motor 220 and rotate at the same speed, in the aforementioned vibration generators 12, the motors 1211 simultaneously operate at different rotational speeds and/or intensity of the respective elliptic vibrations when the motors 1211 simultaneously operate in a state where the motors 1211 are connected to the eccentric rotational force generating means 122 through the rotational driving force transmitting means 123 such as the timing belt, respectively. Thus, the elliptic vibrations caused from the eccentric rotational forces differently generated in the respective vibration generators 12 are combined to be variously changed, and are thus applied to the corresponding body portion with continuous rotational motions. Contrary to monotonous sense in use and simple massage effect obtained since the rotational motion generated when the corresponding body portion is massaged draws the simple trajectory of only the forward or reverse direction, the vibration generators 12 maximizing a variety of massage effects and interest occurring in use is an important feature of the present invention.

Here, the vibration generators 12 may cause their rotational speeds and/or intensity of the respective elliptic vibrations to differ from each other by causing the power supplied from the power supply 14 to the respective vibration generators 12 to differ from each other, by causing weights of the respective eccentric weights 1224 to differ from each other, or by using properties such as clearance between the motors 1211 themselves or between the parts on the driving force transmitting path including the motors 1211. In addition, the respective vibration generators 12 rotate in the same direction or different directions, thereby causing a variety of the massage effects to be experienced.

A raw cloth coated with material, in which anions are generated and lots of far infrared rays are emitted and which have antibiotic and deodorant functions, is provided on a surface of the heating portion 13 which is brought into close contact with the relevant body portion to be massaged. Further, the heating portion 13 comprises a heater 131 for emitting far infrared rays from heat generated when the power is supplied from the power supply 14, and an insulation member 132 for insulating the heat of the heater 131 from the outside.

Due to the vibrations of the vibration generators 12, the far infrared rays generated from the heating portion 13 can be effectively transmitted to the particular body portion.

The power supply 14 may further comprise a cigar jack connector (not shown) capable of supplying necessary power to the massage belt 10 when it is connected to a vehicle cigar jack, so that the massage belt 10 according to the embodiment of the present invention can be employed even in a vehicle. In such a case, the sick body portion such as abdomen, waist or thigh can be massaged irrespective of a place.

The controller 15, which is provided with a power switch, a speed control switch, a heat control switch, and the like, causes the user to freely move and simply operates even in a state where the user wears the massage belt around the particular body portion to be massaged and can control the operation of the vibration generators 12 or the heating portion 13 precisely.

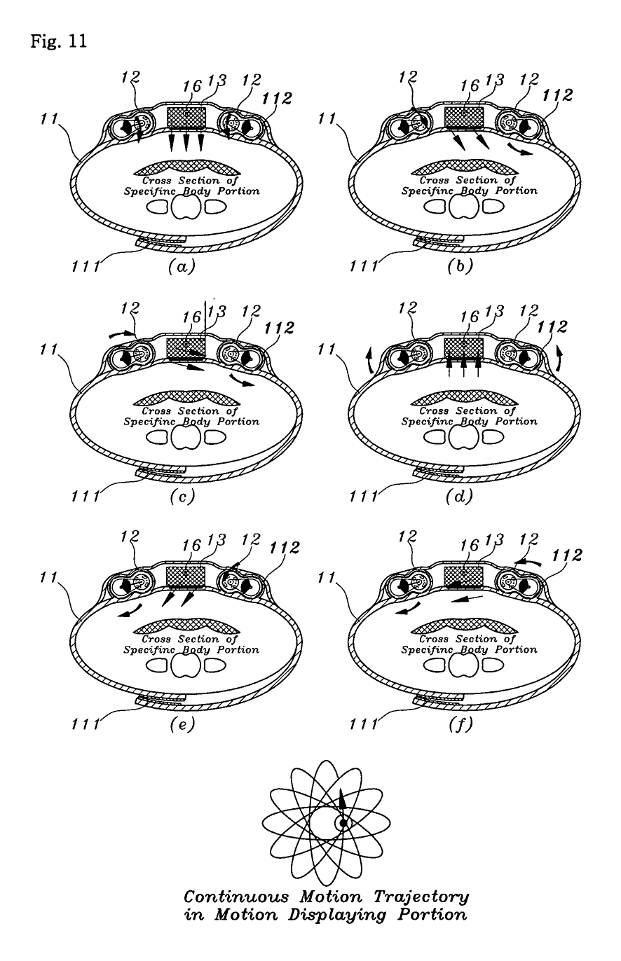

The belt motion displaying portion 16 is installed on the upper end of the belt body 11 so as to visually and immediately confirm that the belt moves and continuously rotates by the elliptic vibrations generated in the vibration generators 12 whenever in use Hereinafter, the operational state of the massage belt according to the embodiment of the present invention so configured will be described in detail with reference to accompanying FIG. 11.

The user wears the belt body 11 around the particular body portion to be massaged such as abdomen or the like and fixes the vibration generators 12 in order to be supported to an abdomen side using the Velcro tape 111.

When the controller 15 is operated in a state where the belt body 11 is wrapped around the particular body portion, the motors 1211 supplied with the corresponding power from the power supply 14 operate according to key input data.

The motor pulleys 1213 rotate when the motors 1211 operate according to the power supplied by the controller 15. The rotational driving force transmitting means 123 such as the timing belts for connecting the motor pulleys 1213 and the eccentric weight pulleys 1225 to each other transmit the rotational driving forces of the rotating motor pulleys 1213 to the eccentric weight pulleys 1225, respectively.

Accordingly, the eccentric weights 1224, which are joined integrally to the eccentric weight pulleys 1225 and rotate together therewith, rotate about the connecting shafts 1221 and generate the centrifugal forces, respectively, so that the centrifugal forces generate the elliptic vibrations and massage the corresponding body portion.

Since the embodiment of the present invention is characterized in that the particular body portion is effectively massaged by the rotational motions which are variously changed due to the combination of the elliptic vibrations generated when the two vibration generators 12, each of which includes the rotational driving means 121 and the eccentric rotational force generating means 122 connected one to one to each other, simultaneously operate at different rotational speeds and/or intensity of the vibrations, contrary to the repetition of the conventional simple and continuous motion of the forward or reverse direction, the present invention provides the optimum massage effects and sense.

In addition, together with the vibrations of the vibration generators 12, the far infrared rays are applied to the particular body portion through the bio ceramic formed around the heater 131 and the portion facing the particular body portion, so that the heating function is provided.

The present invention is not limited to the above embodiment, allows various modifications within the scope of the invention defined by the claims, and includes the modifications.

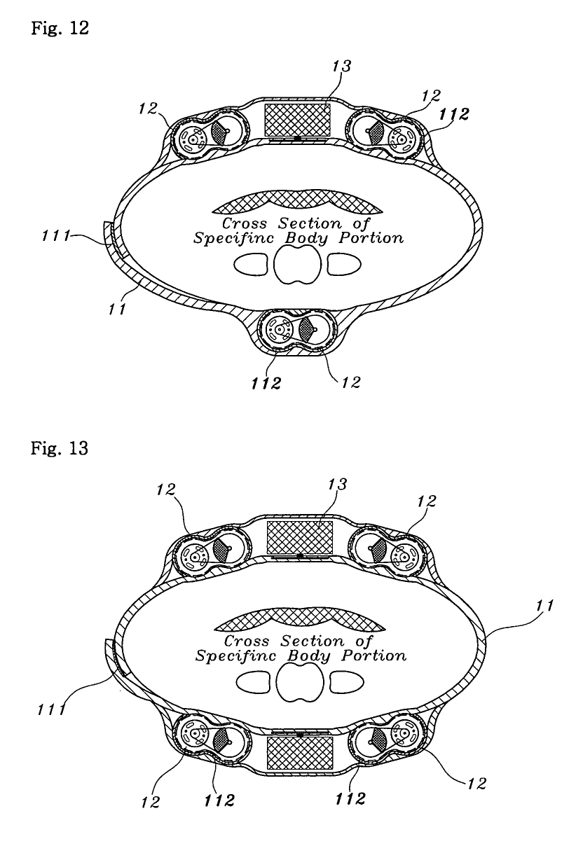

For example, although the vibration generators are positioned at both sides on the front surface of the belt body at a predetermined interval in the aforementioned embodiment of the present invention, a plurality of the vibration generators may be installed in the belt body at any positions of the body portion to be massaged as shown in FIGS. 12 and 13.

### INDUSTRIAL APPLICABILITY

According to the massage belt of the present invention, the vibration generators, which are installed at both sides in the belt body at a predetermined interval to be tightly wrapped around a body portion such as abdomen or waist and to perform massage function, simultaneously operate at different rotational speeds and/or intensity of elliptic vibrations. Therefore, the elliptic vibrations generated differently in the respective vibration generators are combined with each other and variously changed due to the harmony and inharmony repeated from moment to moment, and thus, the vibrations are applied as a continuous motion to the corresponding body portion, whereby it is possible to provide a variety of massage effects and interest occurring in use.

1. A massage belt, comprising:
a belt body tightly wrapped around a body portion to be massaged such as abdomen; and
vibration generators installed at both sides in the belt body at a predetermined interval for generating elliptic vibrations and applying the generated vibrations to the relevant body portion, each comprising a housing, a rotational driving means installed at one side in the housing, an eccentric rotational force generating means installed at the other side in the housing for receiving a rotational driving force from the rotational driving means and generating an eccentric rotational force, and a rotational driving force transmitting means for connecting the rotational driving means and the eccentric rotational force generating means to thereby transmit the rotational driving force of the rotational driving means to the eccentric rotational force generating means,
wherein the vibration generators operate at different rotational speeds and/or intensity of elliptic vibrations to generate vibrations, and continuous rotational motions variously changed due to the combination of the vibrations generated from the vibration generators are applied to the relevant body portion, thereby maximizing a variety of massage effects and interest occurring in use.

2. The massage belt as claimed in claim 1, wherein each of the vibration generators weighs 430 to 730 grams and the massage belt weighs 1300 to 1800 grams as a whole.

3. The massage belt as claimed in claim 1, wherein the eccentric rotational force generating means comprises a connecting shaft with both upper and lower ends being rotatably installed in both upper and lower portions of the other side of the housing, connecting shaft ball bearings for causing the connecting shaft to rotate smoothly, connecting shaft noise prevention rubbers surrounding around the connecting shaft ball bearings to reduce noise when the connecting shaft rotates, an eccentric weight fixed on the connecting shaft to generate the eccentric rotational force, and an eccentric weight pulley fitted and fixed to the eccentric weights.

4. The massage belt as claimed in claim 1, further comprising a heating portion installed in the belt body.

5. The massage belt as claimed in claim 1, wherein a belt motion displaying portion is further installed on an upper end of the belt body to visually indicate the continuous rotational motions variously changed due to the combination of elliptic vibrations generated from the respective vibration generators.
